(19) United States
(12) Patent Application Publication
(10) Pub. No.: US 2011/0213532 A1
(43) Pub. Date: Sep. 1, 2011

(54) METHOD AND SYSTEM FOR CONTROLLING A TWO-SPEED TRANSFER CASE

(76) Inventor: Ricky E. Blair, Crestwood, KY (US)

(21) Appl. No.: 12/715,027

(22) Filed: Mar. 1, 2010

(51) Int. Cl. F16H 59/12

(52) U.S. Cl. 701/52

(57) ABSTRACT

A transfer case control system for a vehicle which includes a transfer case has a mode-selection solenoid, a range-selection solenoid, a control module, a plurality of data inputs, and a plurality of selector switches. The mode-selection solenoid is constructed and arranged to effect a mode change via the transfer case. The range-selection solenoid is constructed and arranged to effect a range change via the transfer case. The control module is electronically coupled to the pair of solenoids and to the plurality of data inputs and to the plurality of selector switches. The plurality of selector switches are actuatable by the vehicle operator and include indicating lamps which provide a visual indication of transfer case status as well as a visual alert to the vehicle operator when a selected operation is not allowed.

### BACKGROUND OF THE INVENTION

A transfer case is utilized as a part of a four wheel drive system which is found in four wheel drive (4WD) and in all wheel drive (AWD) vehicles. The transfer case is constructed and arranged for connection to the vehicle transmission and to the front and rear drive axles of the vehicle all by separate drive shafts. The transfer case receives drive power from the transmission and directs (i.e., transfers) this drive power to the rear axle(s). If the transfer case is not “engaged”, then this drive power connection from the transfer case to the rear drive axle(s) is the only drive power engagement for the vehicle. However, if four wheel drive (4WD) is selected, then the transfer case directs drive power (from the transmission) to both the front and rear drive axles. Although the disclosed method and system are applicable to vehicles with multiple front axles and/or multiple rear axles, the references herein, for simplicity and convenience, are 2WD and 4WD. It is to be understood that the use of “2WD” refers to the transfer of drive torque to the rear drive axle(s) of the vehicle, whether the vehicle has a single rear drive axle or multiple rear drive axles. Similarly, it is to be understood that the use of “4WD” refers to the transfer of drive torque to the front drive axle(s) of the vehicle, as well as to the rear drive axle(s), whether the vehicle has a single front axle or multiple front axles.

In the HIGH range, the transfer case uses the highest gear ratio, usually something close to or approximately a 1:1 ratio. This means that the transfer case has approximately the same input and output speeds in terms of the drive shaft connections. As such, there is no noticeable speed reduction nor any noticeable torque multiplication. In the LOW range, a second gear ratio is used. This lower gear ratio is used to be able to achieve a multiplication of torque. A multiplication of torque would be desired for particular driving conditions or external conditions (including the particular road surface or road surface condition) when more power is required in order to pull the vehicle. It is common to shorten HIGH to HI and LOW to LO for markings, labels, and instructional information. However, HIGH and LOW are used herein.

For the purpose of this disclosure and consistent with the disclosed embodiments, the style of transfer case which is utilized is gear-driven as contrasted to a chain-driven transfer case. Further, clutch technology (i.e., a clutching device) is not used in control and shifting of the transfer case mode, range, or status. Further, the primary focus of this disclosure will be on vehicles having an automatic transmission. However, much of what is disclosed in here with regard to the novel and unobvious method and system is applicable and can be adapted to manual transmission vehicles. Due to the absence of any clutch technology or clutching device used within the transfer case, the style of transfer case described herein is constructed and arranged such that shifting to engage the front drive axle can only be effected at a relatively low speed. While this speed is programmable into a control module, in the preferred embodiment this speed is set at less than 10 mph. Shifting between the LOW range and the HIGH range requires that the vehicle be essentially stopped. An appropriate speed limit is programmed into the control module for this purpose. In the preferred embodiment, this speed is set at less than or equal to 1.0 mph. In terms of the control function, the focus of this disclosure is on the options and decisions which are available to the operator (i.e., the driver of the vehicle) as well as the desire to have suitable alerts and feedback which provide status confirmation to the operator as well as warnings.

In order to avoid excess wear and possible damage to the transfer case and perhaps damage to other drivetrain components, it is important to shift or switch between 4WD (engaged) and 2WD (disengaged) modes only when various vehicle and/or transmission and/or engine conditions are satisfied. Similarly, it is important to shift or switch between HIGH and LOW ranges only when various vehicle and/or transmission and/or engine conditions are satisfied. It is also important for the operator to understand the highway and off-highway conditions and the effect that these may have on the vehicle when 4WD is engaged.

The operator is able to either leave the vehicle in the 2WD mode or engage the transfer case for shifting to the 4WD mode by way of in-cab controls. Therefore, it is important to give the operator sufficient information and feedback regarding the relevant conditions and information so the operator knows when it is safe to change (shift) from one mode to the other. This changing from one mode to the other should only be attempted and only enabled when all of the “right” conditions exist. The operator is also able to switch between HIGH and LOW ranges. Therefore it is important to give the operator sufficient information and feedback regarding the relevant conditions so the operator knows when it is safe to change (shift) from one range to the other. This changing from one range to the other should only be attempted and only enabled when all of the “right” conditions exist. The present disclosure is directed to a method and system which (1) provides important information to the operator regarding the relevant conditions, and (2) manages the operation of the transfer case in order to reduce the likelihood of excess wear and/or damage. The reference to managing the operation applies to “shifting” between engaged and disengaged modes as well as shifting between HIGH and LOW ranges.

When vehicles are still in the specification stage prior to construction, a great deal of thought and calculation goes into determining what tires and gear ratios will be best suited to the engine and transmission combination being used. This is especially true of AWD (all-wheel-drive) type vehicles because front and rear drive axles are interconnected through the transfer case, and therefore vulnerable to the adverse effects of differential tire speed. The most prominent of these adverse conditions is called “wind-up” which is caused by ratio “mis-match”. Effectively, this means that by virtue of different tire sizes or gear ratios from front to rear, one set of tires is trying to turn faster than the other. This generates excessive amounts of torque (wind-up) which is transmitted through the drivetrain. These extreme torsional loads can cause damage to differential gears, transfer cases, even engines and transmissions. As close as engineers try to match gear ratios and tires for a given application, the reality is that there will always be some degree of mis-match between front and rear axles. When a vehicle is operated on a hard, dry surface with the front axle engaged (AWD or 4WD, etc.), the tires are not able to slip and relieve the torsional forces being generated.

As already mentioned, there are shifting limitations with the style of transfer cases disclosed herein due to the absence of any clutching mechanism or device. Improper shifting is likely to result in two different types of internal and external damage. The first is degradation of the engagement teeth due to relative motion of drive gears and shift collars. This type of damage can prevent the transfer case from shifting normally as the teeth become burred and cannot mesh. The second condition imparts excessive shock loading throughout the entire drivetrain. This occurs when a shift is attempted at a precise moment of tooth alignment (gears meshing), and the shift is actually completed at excessive speed. This results in high torque loading that is transmitted through the transfer case, driveshafts, and axles. The extent of the damage possible increases proportionately with the vehicle speed. Over the years, efforts have been made to try and protect end users (operators) from this mode of failure with operational placards, audible warnings, and light signals. Despite these efforts, vehicles manufacturers and/or component suppliers have not yet been able to fully discourage these destructive practices.

Although transfer case technology is fairly well known, there have been only limited efforts directed to the monitoring and management of shift selection options and the decisions being made by the vehicle operator. U.S. Pat. No. 6,297,566, issued Oct. 2, 2001 to Lahr et al., is directed to engaging and disengaging auxiliary equipment in a manner intended to reduce the risk of damage to that auxiliary equipment. Although the specific items of auxiliary equipment are not mentioned, it is assumed that items such as a hydraulic pump and a water pump. are intended. The front drive axle is not specifically mentioned in terms of switching between 2WD and 4WD modes. There is also no mention of switching between a LOW range and a HIGH range. More specifically, a two-speed transfer case is not mentioned in the '566 patent. Further, this disclosed system requires a parking brake switch to assess the status of the parking brake. This added cost and complexity is not required for the embodiments disclosed and claimed herein. The '566 system also utilizes a speed sensor to assess the driveshaft speed. This technology then requires a timer to account for inaccurate zero-speed readings from the sensor. The embodiments disclosed and claimed herein are less costly and less complex, since the actual vehicle speed is used and is taken directly from the already-present J1939 network.

In order to improve upon the prior art methods and systems for controlling a two-speed transfer case, and in order to focus on the prevention of operator errors (or poor decisions), the present disclosure provides a novel and unobvious method and system. The disclosed method and system introduces additional safeguards for the utilization of the transfer case in conjunction with the types of vehicles disclosed herein.

### BRIEF SUMMARY

Disclosed is the combination of a vehicle transfer case and a transfer case control system for the vehicle. The transfer case is constructed and arranged to operate based on gear engagement. The transfer case control system includes a mode-selection solenoid, a range-selection solenoid, a control module, a plurality of data inputs, and a plurality of selector switches. The mode-selection solenoid is constructed and arranged to effect a mode change via the transfer case. The range-selection solenoid is constructed and arranged to effect a range change via the transfer case. The control module is electronically coupled between the plurality of data inputs and the mode-selection and range-selection solenoids. The control module is also electronically coupled to the plurality of selector switches which are actuatable by a vehicle operator. These selector switches include indicating lights for providing a visual indication of the transfer case status and a visual alert to the vehicle operator when a selected operation is not allowed.

One object of the present disclosure is to describe an improved transfer case control system.

### BRIEF DESCRIPTION OF THE SEVERAL VIEWS OF THE DRAWINGS

FIG. 1 is a diagrammatic, perspective view of a vehicle chassis including a vehicle drive system with a transfer case.

FIG. 2 is schematic diagram of a control system associated with the FIG. 1 vehicle drive system and transfer case.

FIG. 3 is a diagrammatic, full section view of the FIG. 1 transfer case showing the input and output options.

FIG. 4 is a diagrammatic illustration of the in-cab controls which are available to the operator of the vehicle which includes the FIG. 1 vehicle drive system.

### DETAILED DESCRIPTION

For the purposes of promoting an understanding of the disclosure, reference will now be made to the embodiments illustrated in the drawings and specific language will be used to describe the same. It will nevertheless be understood that no limitation of the scope of the disclosure is thereby intended, such alterations and further modifications in the illustrated device and its use, and such further applications of the principles of the disclosure as illustrated therein being contemplated as would normally occur to one skilled in the art to which the disclosure relates.

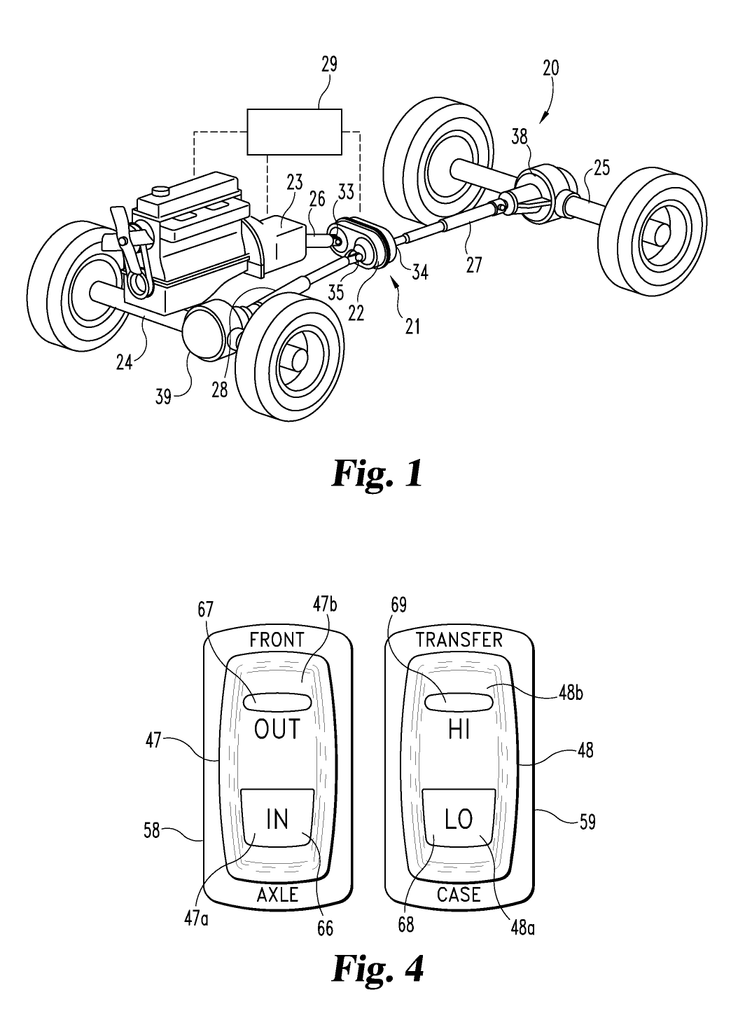

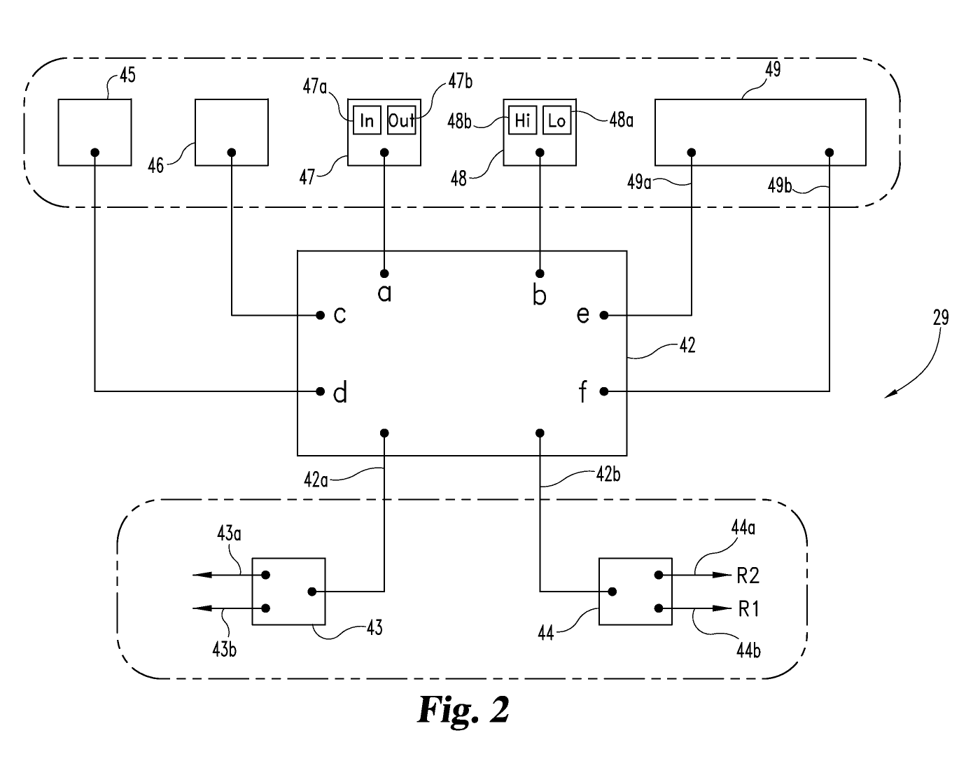

Referring to FIG. 1, there is illustrated, in diagrammatic form, a vehicle chassis 20 which includes some of the basic components of a vehicle drive system 21. Vehicle drive system 21 includes, also by way of diagrammatic representations, transfer case 22, vehicle transmission 23, front drive axle 24, rear drive axle 25, and drive shafts 26, 27, and 28. Electronics package 29 handles vehicle condition inputs and includes operator control switches (see FIGS. 2 and 4). The transmission 23 and transfer case 22 are connected by way of driveshaft 26 for the transfer of driving torque from the transmission to the input 33 of the transfer case. The 2WD output 34 from the transfer case 22 is connected to the rear drive axle 25 by way of driveshaft 27. The rear drive axle connection is maintained whether the transfer case is disengaged and remains in 2WD mode or engaged for 4WD mode. When the gearing arrangement of the transfer case is “engaged” (i.e., switching or shifting to 4WD), a second output 35 from the transfer case 22 is connected to the front drive axle 24 by way of driveshaft 28. The first output 34 remains connected to the rear drive axle 25. Driveshaft 27 connects to the differential 38 of the rear drive axle 25. Driveshaft 28 connects to the differential 39 of the front drive axle 24.

Referring now to FIG. 2, a schematic diagram of the circuitry and data connections is provided. This diagram is identified as corresponding to electronics package 29. The referenced vehicle settings, status information, and controls associated with the vehicle drive system are depicted as flow diagram blocks with the data path connections. These various vehicle settings, status information, and controls are processed by the control module 42 based on its programming and the specific electrical engineering functions associated with this task are believed to be well within the general knowledge of an electrical engineer based on what is disclosed herein and what is desired. Control module 42 is connected to front axle solenoid 43 and to transfer case ratio solenoid 44. Solenoid 43 is a mode-selection solenoid which is constructed and arranged to effect a mode change via the transfer case 22. Similarly, solenoid 44 is a range-selection solenoid which is constructed and arranged to effect a range change via the transfer case 22. The control module 42 is powered by the vehicle battery (12 VDC) power and is grounded. These connections are not illustrated but would be understood as part of a vehicle or engine control module.

Solenoids 43 and 44 are mounted inside of an aluminum enclosure (not illustrated) which is mounted with threaded fasteners to the inside of a chassis frame rail in close proximity to the location of transfer case 22. Included within this enclosure are the associated electronics for control of the solenoids 43 and 44. Control is based on data and signal inputs from the switches 47 and 48 and the related electronics, such as control module 42. The solenoids 43 and 44 are pneumatically connected to an air input source (not illustrated) and to their corresponding transfer case air connections.

The various data and signal information and inputs which are connected to the control module 42 are provided by transfer case ratio indicator switch 45, front axle indicator switch 46, front axle engage/disengage selector switch 47, transfer case ratio selector switch 48, and the J1939 vehicle communication network 49. Indicator switch 45 is connected to input “d” of the control module 42. Indicator switch 46 is connected to input “c” of the control module. Selector switch 47 is connected to input “a” of the control module. Selector switch 48 is connected to input “b” of the control module. The J1939 network 49 provides two signals to the control module 42. Output 49a provides vehicle speed data to input “e” of the control module. Output 49b provides information regarding the current transmission gear selection to input “f” of the control module. The J1939 network is the standard vehicle bus which is used for communication and diagnostics among vehicle components. The control module is electronically coupled to each of these various data inputs and the control module is also electronically coupled to the two solenoids 43 and 44.

The indicator switch 45 provides an input signal to the control module which identifies the current mechanical condition of the transfer case gear ratio of the vehicle drive system. Indicator switch 46 provides an input signal to the control module which identifies the current mechanical condition of the drive mode. The drive mode options are either 2WD or 4WD, the latter corresponding to engagement of the front drive axle via the transfer case and drive torque being connected to the front drive axle 24. Selector switch 47 is mounted inside of the vehicle (i.e., in-cab) where the two selection portions 47a and 47b (see FIG. 4) are accessible to the operator of the vehicle. Selector switch 47 is a momentary-contact rocker switch with upper and lower portions 47a and 47b which could be replaced by separate control buttons appropriately wired with alternative circuitry.

The IN selection (portion 47a) is selected by the operator of the vehicle in order to engage the front drive axle and put the vehicle into 4WD. The OUT selection (portion 47b) is selected by the operator of the vehicle in order to disengage the front drive axle and return the vehicle to 2WD. Selector switch 48 is also mounted inside of the vehicle where the two selection portions 48a and 48b (see FIG. 4) are accessible to the operator of the vehicle. Similar to what has been described for selector switch 47, selector switch 48 is a momentary-contact rocker switch with upper and lower portions 48a and 48b which could be replaced by separate control buttons with appropriate wiring and control circuitry.

The operator of the vehicle is able to select between two gear ratios, identified as HIGH range (portion 48b) and LOW range (portion 48a). Ratio (R1) is the HIGH range and, as previously noted, this is usually something in the range of approximately 1:1. However, the specific ratio, whether 1:1 or 0.89:1 or some other ratio, is not important in terms of the disclosed method and system. This is one reason for the more generic reference of ratio R1. Ratio R2 is the LOW range and the actual ratio depends on the vehicle and what might be desired or felt to be appropriate by the engineers responsible for vehicle and drive specifications. Since there are a wide variety of vehicles which could be equipped with the control system disclosed herein, ratio R2 should be thought of as something in the range from between approximately 1.5:1 and 3.5:1. However, the specific ratio, whether within the range or some other ratio outside of this range, is not important in terms of the disclosed method and system. This is one reason for the more generic reference of ratio R2.

Solenoid 43 is connected to one output 42a of control module 42 and is operable in one of two states or conditions, engage or disengage. These states or conditions correspond to control of the gearing arrangement within the transfer case. In the “engage” state or condition of solenoid 43, the transfer case gearing is engaged and the vehicle drive system is put into the 4WD mode. This amounts to transferring drive torque to the front drive axle 24. In the “disengage” state or condition of solenoid 43, transfer case gearing is disengaged and the vehicle drive system returns (or remains) in the 2WD mode. Solenoid 43 is constructed such that its two available states or conditions (engage and disengage) are represented by the two air output lines 43a (engage) and 43b (disengage).

Solenoid 44 is connected to another output 42b of control module 42 and is operable in one of two states or conditions. These two states or conditions are the HIGH range (ratio R1) and the LOW range (ratio R2). The more generic references of R1 and R2 for these two ratios are used in order to convey the understanding that the specific ratio values can vary, depending on the particular vehicle and depending on what the design engineers felt would be the appropriate or desired HIGH and LOW ranges for that vehicle and for the corresponding transfer case.

In the first state or condition of solenoid 44, the transfer case gearing is engaged in such a way as to create the HIGH range R1 ratio. In the second state or condition of solenoid 44, the transfer case gearing is engaged in such a way as to create the LOW range R2 ratio. The solenoid 44 construction is such that its two available states or conditions (R1 ratio and R2 ratio) are represented by the two air output lines 44a and 44b.

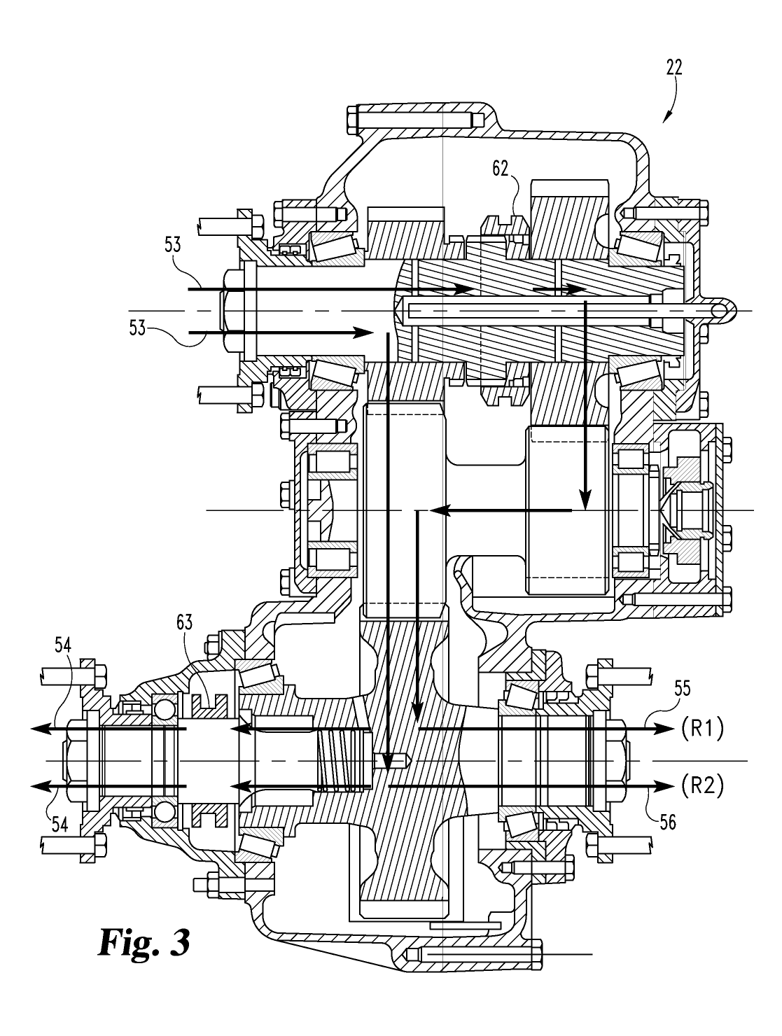

Referring to FIG. 3, the interior gearing of transfer case 22 is diagrammatically illustrated. Since the basics of transfer case construction are assumed to be well known, only a couple of points need to be clarified. First, the disclosed gearing arrangement does not include any clutches or clutch mechanisms. Secondly, the gears which are selected correspond to the R1 and R2 ratios which are desired. The diagrammatic illustration of FIG. 3 includes a series of torque transfer arrows which denote the gear engagement path between the transmission input (arrows 53) and the outputs. Output arrows 54 represent the engage condition for the 4WD mode. Output arrow 55 represents the selection of the first ratio (R1). Output arrow 56 represents the selection of the second ratio (R2).

Referring now to FIG. 4, the interior (i.e., in-cab) shift control portions 47a, 47b, 48a, and 48b are illustrated as part of their corresponding switch panels 58 and 59. Panel 58 includes rocker switch 47 which provides the front axle switch portions 47a (IN) and 47b (OUT). Panel 59 includes rocker switch 48 which provides the range selection for the transfer case and includes portions 48a (LOW) and 48b (HIGH). These two switch panels are positioned side-by-side in close proximity to the operator of the vehicle such that there is easy access to all four switch portions.

Briefly, the operational aspects are as follows. Portion 47a is to be pressed and released in order to engage the front drive axle 24 for 4WD. Portion 47b is to be pressed and released in order to disengage the front drive axle and return or restore the vehicle to its normal 2WD mode. Portion 48a is to be pressed and released in order to shift the transfer case from the HIGH range to the LOW range. Portion 48b is to be pressed and released in order to shift the transfer case from the LOW range to the HIGH range. This range shifting is permitted in both the 2WD mode and the 4WD mode.

Now that the layout and structural elements have been described, the use of vehicle drive system 21 and the associated electronics package 29 and the control or selector switches 47 and 48 will now be described. As described, the vehicle includes a transfer case 22 through which an engine and transmission can deliver torque to an axle or to multiple axles in order to propel the vehicle in multiple output ratios. The disclosed construction for engaging and disengaging the front drive axle 24 from the transfer case 22 and for selecting one of two output ratios (R1 or R2) contains a first solenoid 43 which is selectively operable to a first state (2WD) when the vehicle is to be propelled with the front driving axle(s) disengaged and a second state (4WD) when the vehicle is to be propelled with the front driving axle(s) engaged. A second solenoid 44 is provided and is selectively operable to a first state where the transfer case output is a first gear ratio and a second state where the transfer case output is a second gear ratio. The control module 42 controls solenoids 43 and 44 and receives a first input (a) from the front axle engage/disengage selector switch 47 for requesting operation of the first solenoid 43 in its first and second states. The second input (b) from the transfer case ratio selector switch 48 is used for requesting operation of the second solenoid 44 in its first and second states. A third input (c) comes from the front axle indicator switch 46 for signaling the current mechanical condition. A fourth input (d) comes from the transfer case ratio indicator switch 45 for signaling the current mechanical condition. A fifth input (e) comes from the J1939 communications network 49 for signaling vehicle speed. A sixth input (f) also comes from the J1939 communications network 49 for signaling current transmission gear selection.

When the first input (a) to the control module 42 signals that engagement has been requested, the control module 42 then verifies that the third input signal (c) is disengaged and that the fifth input signal (e) is a vehicle speed below a pre-selected limit (less than 10 mph). If these conditions are met, then the control module 42 powers the first solenoid 43 to apply air to the transfer case 22 (arrow 43a) and to move the shift collar 62 to engage the front drive axle 24. When the first input (a) signals that disengagement has been requested, the control module then verifies that the third input signal (c) is engaged and that the fifth input signal (e) is a vehicle speed below a pre-selected limit (less than 25 mph). If so, then the control module 42 powers the first solenoid 43 to remove air from the transfer case 22 (arrow 43b) and move the shift collar 62 to disengage the front drive axle 24. When the third input signal (c) is engaged and the fifth input signal (e) reaches a pre-determined maximum speed, the control module automatically powers the first solenoid 43 to remove air from the transfer case 22 and move the shift collar 62 to disengage the front drive axle. When the second input signal (b) indicates that a shift from its first ratio (R1) to its second ratio (R2) has been requested, the control module 42 verifies that the fourth input signal (d) is the first ratio (R1), the fifth input signal (e) is a vehicle speed below a pre-selected limit (≦1 mph), and the sixth input (f) is neutral. If so, the control module 42 powers the second solenoid 44 to apply air (arrow 44a) to the transfer case 22 and move the shift collar 63 to the second ratio (R2). When the second input signal (b) indicates that a shift from the second ratio (R2) to its first ratio (R1) has been requested, the control module 42 verifies that the fourth input signal (d) is the second ratio (R2), the fifth input signal (e) is a vehicle speed below a pre-selected limit (≦1 mph), and the sixth input (f) is neutral. If so, the control module powers the second solenoid 44 to apply air to the transfer case 22 and moves the shift collar 63 to the first ratio (R1).

The operational sequences and combinations, as described above, are further summarized by the following charts.

| I. | Solenoid 43 IN = engage front drive axle/OUT = disengage | |
|---|---|---|
| | front drive axle | |
| A. | Actuates OUT when: | |
| | 1. | 12 VDC power is present.* |
| | 2. | a ground is present. |
| | 3. | rocker switch 47 (OUT 47b is selected) - default. |
| | 4. | front axle indicator switch 46 ≠ OUT |
| | 5. | vehicle speed < 25 mph (forced out at 25 mph) |
| B. | Actuates IN when: | |
| | 1. | 12 VDC power is present.* |
| | 2. | a ground is present. |
| | 3. | rocker switch 47 (IN 47a is selected). |
| | 4. | front axle indicator switch 46 ≠ IN |
| | 5. | vehicle speed < 10 mph. |
| II. | Solenoid 44 HIGH (ratio R1) - LOW (ratio R2) | |
| A. | Actuates HIGH range when: | |
| | 1. | 12 VDC power is present.* |
| | 2. | a ground is present. |
| | 3. | rocker switch 48 (HIGH 48b is selected) - default. |
| | 4. | transfer case indicator switch 45 ≠ HIGH |
| | 5. | vehicle speed ≦ 1 mph. |
| | 6. | transmission position = NEUTRAL. |
| B. | Actuates LOW range when: | |
| | 1. | 12 VDC power is present.* |
| | 2. | a ground is present. |
| | 3. | rocker switch 48 (LOW 48a is selected). |
| | 4. | transfer case indicator switch 45 ≠ LOW. |
| | 5. | vehicle speed ≦ 1 mph. |
| | 6. | transmission position = NEUTRAL. |

*In the event power is not provided or is otherwise not available, the default (no power) states are OUT and HIGH.

As described, the disclosed vehicle drive system 21, including and in cooperation with the electronics package 29 and the selector switches 47 and 48, is constructed and arranged to help reduce the risk of operator error or at least poor decisions when intending to shift out of 2WD mode into 4WD mode and then changing or shifting between the HIGH range and LOW range. Whether the operator error is due to simply making a poor decision or is due to a misunderstanding of the vehicle operation and/or the corresponding road or surface conditions, the focus of the disclosed embodiment is on preventing excessive wear and/or damage to the transfer case and perhaps other portions of the vehicle and vehicle drive system.

For example, assume that the vehicle is being operated in an off-highway setting with the front drive axle engaged (4WD). Assume further that the operator then drives the vehicle onto a non-slip highway surface such as asphalt or concrete The question is what will happen if the operator does not disengage the 4WD mode under these circumstances? Ideally, there would still be a 1:1 ratio in the HIGH range, but there is typically some mismatch, if due only to differences in tire wear. If the vehicle is driven for any length of time with this ratio mismatch, there will be damage to the transfer case and there could be damage to other drive system components. Since this described situation would likely be a case where the vehicle is driven at a speed in excess of 25 mph on the highway once it leaves the off-highway surface, this speed is set as the threshold for auto-disengagement. See the entries of the first chart as set forth above. It is noted that there is a 25 mph setting which causes front drive axle disengagement. This particular safety feature (i.e. a selected speed limit) is programmed into the control module and the specified default speed could be higher or lower than 25 mph. Since this particular speed setting is programmable, some decision can be made at the design stage as to an appropriate disengagement speed.

A second situation of concern is how to guarantee proper gear tooth mesh since the transfer case 22 does not include any clutches or clutch mechanism. The gear teeth typically have a square tooth profile and proper mesh might not be achieved. If acceleration is attempted without a proper gear mesh, tooth interference and grinding will occur. This situation is intended to be prevented by the control settings and inputs which are required to be present as shown in the charts set forth above. These conditions have to be satisfied in order to change from HIGH range to LOW range or to change from LOW range to HIGH range. The intent is that, once these various settings are present so as to enable to shift from one range to the other, proper gear mesh will be achieved and thereby reduce wear and/or potential damage.

The operator is provided with additional information regarding the use and operation of the vehicle drive system, including the operation and use of the electronics package and the rocker switches 47 and 48. This additional information is provided by four lamps and printed guidelines or explanations. As described above, the front axle IN selection (portion 47a) is used to engage the front drive axle 24 for 4WD. This portion 47a includes an indicator light or lamp 66. Portion 47b (OUT) is selected to disengage the front drive axle and includes indicator light or lamp 67. Portion 48a (LOW range) is selected to shift from HIGH range to LOW range and includes indicator light or lamp 68. Portion 48b (HIGH range) is selected to shift from LOW range to HIGH range when in 4WD and includes indicator light or lamp 69. Each portion 47a, 47b, 48a, and 48b is associated with a corresponding rocker switch 47 and 48, respectively, and each switch has a momentary-contact action. This momentary-contact action is also described as a “press and release” action.

If, after the press and release action of portion 47a, there is a blinking green light from lamp 66, this is an indication to the vehicle operator that the requested operation has been accepted and will occur as soon as the (automatic) transmission is shifted out of NEUTRAL. This is the same sequence for portion 48a and the selection of the LOW range. If, after the press and release action, there is a blinking green light from lamp 68, this is an indication to the vehicle operator that the requested operation has been accepted and will occur as soon as the (automatic) transmission is shifted out of NEUTRAL.

A constant or steady green light from lamp 66 indicates that the front drive axle 24 is engaged (i.e., 4WD). This is a visual indication to the operator that there is no need to press and release portion 47a since the front drive axle is already engaged. This same configuration applies to portion 48a and the selection of the LOW range. If lamp 68 provides a constant or steady green light, this is an indication to the operator that the drive system is currently in the LOW range. The constant green light visually informs the operator that there is no need to try and effect this particular selection.

While the constant or steady green light only applies to portions 47a (IN mode) and 48a (LOW range), a “not illuminated” light status for selector switch 47 (lamp 66) corresponds to a disengaged status for the front drive axle. Similarly, a “not illuminated” light status for selector switch 48 (lamp 68) corresponds to the HIGH range status for the vehicle drivetrain.

Considering lamps 67 and 69, these two lamps are constructed and arranged and electrically wired to provide a blinking amber light if the requested (selected) operation is not allowed. In terms of “not allowed”, this means that not all of the conditions (i.e., data inputs) required to safely perform the requested operation are present. A blinking amber light, limited to lamps 67 and 69, is a form of visual feedback to the operator that the desired selection is not permitted since one or more of the required data inputs are not present. There is one further lamp illumination option or status to mention. When the front drive axle is engaged and the operator selects portion 47b (OUT) to disengage, the gear mesh and torque status within the transfer case influences the outcome. A blinking green light from lamp 66 indicates that the system will disengage, but not until these other transfer case conditions are suitable. A similar option or status is applicable to lamp 68. When in the LOW range and the operator selects the HIGH range, a blinking green light from lamp 68 is a visual indication that the shift will be made when all required conditions (including the transfer case conditions) are met.

The control module 42 checks its data inputs and the programmed requirements (i.e., the conditions which need to be present) and decides whether it is safe to “power” the appropriate solenoid 43 or 44. Further, the operator is advised that the vehicle speed must be essentially 0 mph (stopped) and that the automatic transmission must be in NEUTRAL before any switch operations will be allowed. These controls and operational strategies are provided in part by the electronics package 29, the particular programming of the control module 42, and by the various data transmission connections. An instruction card, placard, or decal with much of the foregoing information is made available to the operator. This instruction card, placard, or decal is provided in the cab in plain view. Likely locations are the dashboard or sun visor.

The transfer case control system which has been described herein includes solenoids 43 and 44, control module 42, data inputs and switches 45-49 collectively, and the associated wiring and electrical connections.

While the preferred embodiment of the invention has been illustrated and described in the drawings and foregoing description, the same is to be considered as illustrative and not restrictive in character, it being understood that all changes and modifications that come within the spirit of the invention are desired to be protected.

1. In combination:
a transfer case constructed and arranged to operate based on gear engagement; and
a transfer case control system for a vehicle which includes the transfer case, said transfer case control system comprising:
a mode-selection solenoid constructed and arranged to effect a mode change via said transfer case;
a range-selection solenoid constructed and arranged to effect a range change via said transfer case;
a control module electronically coupled to said mode-selection solenoid and to said range-selection solenoid;
a plurality of data inputs electronically coupled to said control module; and
a plurality of selector switches actuatable by a vehicle operator, said plurality of selector switches including indicating means for providing a visual indication of transfer case status and a visual alert to the vehicle operator when a selected operation is not allowed, wherein a specific set of data inputs is required in order for the transfer case control system to allow said selected operation.

2. The combination of claim 1 wherein said plurality of data inputs include an input from a J1939 communications network which is a portion of vehicle electronics.

3. The combination of claim 1 wherein said plurality of data inputs include data from a transfer case ratio indicator switch, a front axle indicator switch, a front axle selector switch, and a transfer case selector switch.

4. The combination of claim 1 wherein selectable mode options include engaged and disengaged relative to a front drive axle of said vehicle.

5. The combination of claim 4 wherein said engage mode is permitted by said control module only when specific conditions are satisfied, one of said specific conditions being a vehicle speed below a specified limit.

6. The combination of claim 5 wherein said specified limit is approximately 10 miles per hour.

7. The combination of claim 6 wherein said vehicle speed is provided by a J1939 communications network.

8. The combination of claim 4 wherein a disengage mode results from a speed default setting.

9. The combination of claim 8 wherein said default setting speed is set at approximately 25 miles per hour.

10. The combination of claim 4 wherein one selector switch corresponds to said selectable mode options.

11. The combination of claim 10 wherein said one selector switch includes an indicator lamp corresponding to each selectable mode option.

12. The combination of claim 1 wherein said range options include HIGH and LOW wherein said HIGH range has an associated gearing ratio and said LOW range has an associated gearing ratio.

13. The combination of claim 12 wherein said HIGH range option requires a NEUTRAL transmission status for the selection to be permitted by said transfer case control system.

14. The combination of claim 12 wherein said LOW range option requires a NEUTRAL transmission status for the selection to be permitted by said transfer case control system.

15. A transfer case control system for controlling mode and range of a vehicle transfer case, said transfer case control system comprising:
a mode-selection solenoid operable to engage or disengage a drive axle via said vehicle transfer case;
a range-selection solenoid operable to effect a range selection of either HIGH range or LOW range to be effected via said vehicle transfer case;
a control module electronically coupled to said mode-selection solenoid and to said range-selection solenoid;
a plurality of data inputs electronically coupled to said control module; and
a plurality of selector switches actuatable by a vehicle operator, said plurality of selector switches including indicating means for providing a visual indication of transfer case status and a visual alert to the vehicle operator when a selected operation is not allowed, wherein a specific set of data inputs is required in order for the transfer case control system to allow said selected operation.

16. The transfer case control system of claim 15 wherein said plurality of data inputs include an input from a J1939 communications network which is a portion of vehicle electronics.

17. The transfer case control system of claim 15 wherein said plurality of data inputs include data from a transfer case ratio indicator switch, a front axle indicator switch, a front axle selector switch, and a transfer case selector switch.

18. The transfer case control system of claim 15 wherein said disengage mode results from a speed default setting.

19. The transfer case control system of claim 18 wherein said default setting speed is set at approximately 25 miles per hour.

20. The transfer case control system of claim 15 wherein said HIGH range option requires a NEUTRAL transmission status for the selection to be permitted by said transfer case control system.

21. The transfer case control system of claim 15 wherein said LOW range option requires a NEUTRAL transmission status for the selection to be permitted by said transfer case control system.

22. A method of controlling a transfer case which is a part of a vehicle drive system, said vehicle drive system including an electronics package and a pair of selector switches accessible to a vehicle operator, said method of controlling including the following steps:
a.) engaging a control switch to select 4WD;
b.) monitoring a signal lamp to assess the status of the 4WD selection;
c.) verifying that the vehicle is in 4WD mode;
d.) engaging a control switch to select a LOW gear ratio; and
e.) monitoring a signal lamp to assess the status of the LOW gear ratio selection.
